(19) United States
(12) Patent Application Publication
(10) Pub. No.: US 2009/0325404 A1
(43) Pub. Date: Dec. 31, 2009

(54) ELECTRICAL CONNECTOR WITH IMPORVED CONTACTS

(75) Inventors: NAN-HUNG LIN, Tu-Cheng (TW); CHENG-CHI YEH, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION INDUSTRY CO., LTD., Tu-Cheng (TW)

(21) Appl. No.: 12/494,328

(22) Filed: Jun. 30, 2009

(30) Foreign Application Priority Data
Jun. 30, 2008 (TW) 97211566

(51) Int. Cl. H01R 12/00

(52) U.S. Cl. 439/73

(57) ABSTRACT

An electrical connector includes a socket body, a retention frame adjacent to the socket body, and a load plate attached to the retention frame and capable of rotating toward or away from the socket from an open position to a close position. A number of contacts are attached to the socket body and each has a base section, a retention section extending upwardly from the base section, a contact section bending from the retention section, and a tail section extending downwardly from the base section. The tail section includes a stick section and a reinforcement section bending from the stick section for increasing the rigidity of the tail section.

### BACKGROUND OF THE INVENTION

1. Field of the Invention

The present invention relates to an electrical connector, and more particularly to an electrical connector which is mounted on a printed circuit board (PCB) for receiving an IC package, and which has improved contacts for securing to the PCB.

2. Description of Related Art

Central Processing Unit (CPU) and other electrical package, generally referred to as IC package, commonly works via an electrical connector mounted on a printed circuit board, which includes at least a socket with a number of contacts for electrical connection with the IC package and securing means for fastening the IC package.

U.S. Pat. No. 7,278,860 issued to Hao-Yun Ma on Oct. 9, 2007 discloses such an electrical connector, which is soldered on a printed circuit board to receive an IC package. Referring to FIG. 1 and FIG. 4 of this patent, the electrical connector includes an insulative housing with a number of contacts received therein, a metallic stiffener located around the housing, a load plate for pressing an IC package seated on the housing, and a load lever for fastening the load plate.

Chinese Patent Issue No. 2427899 issued to He on Apr. 25, 2001 discloses another CPU socket, which includes an insulative housing, a plurality of electrical contacts retained in the housing, a cover plate shielding the insulative housing, and an actuator driving the cover plate to slide on the housing. Each electrical contact includes a base, a retention section upwardly extending from the base, a contact section for contacting with the package, and a tail extending downwardly from the base. The tail is generally inserted into through holes of the PCB and has a rib formed thereon to increase the intensity. However, with the trend of miniature, not only the package turns to smaller, but also the connector and the area of PCB for mounting the connector turn to smaller. Accordingly, the size of the contacts and the through holes on PCB are also decreased. Therefore, the tail received in the through holes becomes easily deformed for the small size.

Thus, there is a need to provide a new electrical connector that overcomes the above-mentioned problems.

### BRIEF SUMMARY OF THE INVENTION

Accordingly, an object of the present invention is to provide a burn-in socket with contacts reliably contacting with the IC package.

In order to obtain the object, an electrical connector for electrical connecting package with printed circuit board comprises a socket body, a retention frame adjacent to the socket body, and a load plate attached to the retention frame and capable of rotating toward or away from the socket from an open position to a close position. A plurality of contacts are attached to the socket body and each comprises a base section, a retention section extending upwardly from the base section, a contact section bending from the retention section, and a tail section extending downwardly from the base section. The tail section includes a stick section and a reinforcement section bending from the stick section for increasing the rigidity of the tail section.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is a perspective view of an electrical connector mounted to a PCB according to a preferred embodiment of the present invention;

FIG. 2 is similar to FIG. 1, while shows the cover is in an open position;

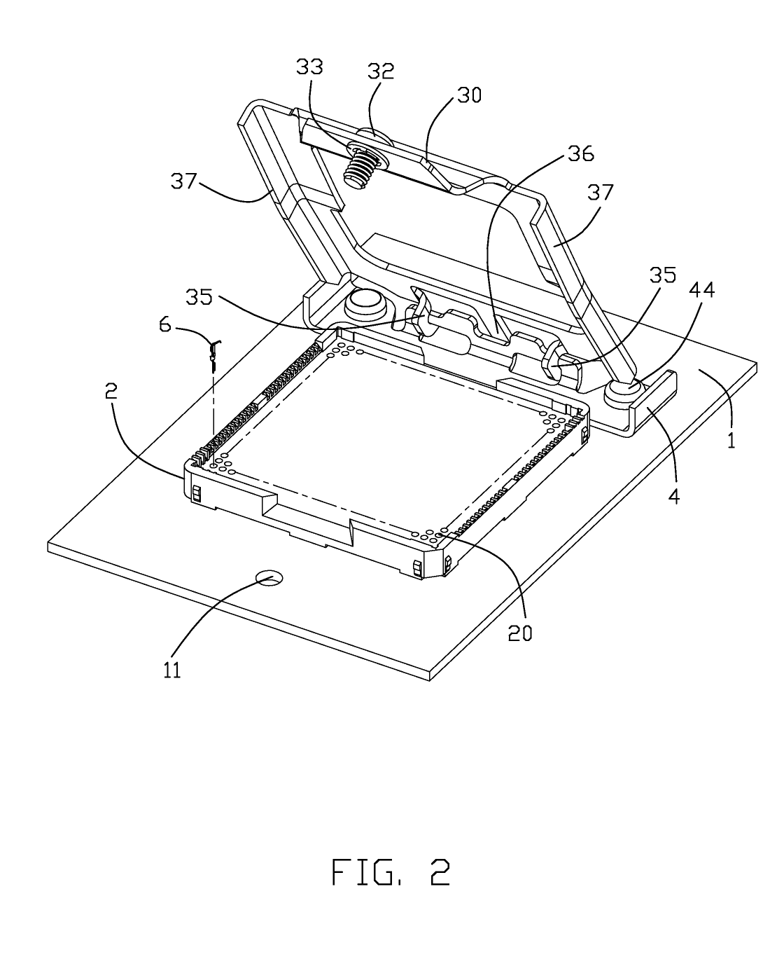

FIG. 3 is an exploded view of the electrical connector shown in FIG. 1;

FIG. 4 is a perspective view of the electrical contact shown in FIG. 2;

FIG. 5 is a sketch view of the electrical contact according to a second embodiment of the present invention;

FIG. 6 is a sketch view of the electrical contact according to a third embodiment of the present invention;

FIG. 7 is a sketch view of the electrical contact according to a fourth embodiment of the present invention; and

FIG. 8 is a sketch view of the electrical contact according to a fifth embodiment of the present invention.

### DETAILED DESCRIPTION OF THE PREFERRED EMBODIMENT

Reference will be made to the drawing figures to describe the present invention in detail, wherein depicted elements are not necessarily shown to scale and wherein like of similar elements are designated by same or similar reference numeral through the several views and same or similar terminology.

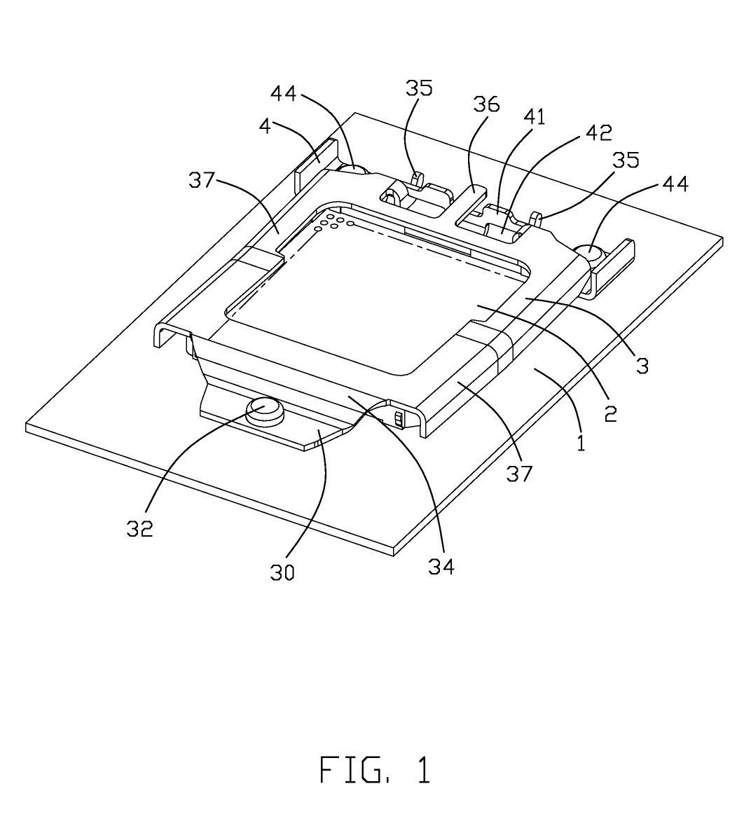

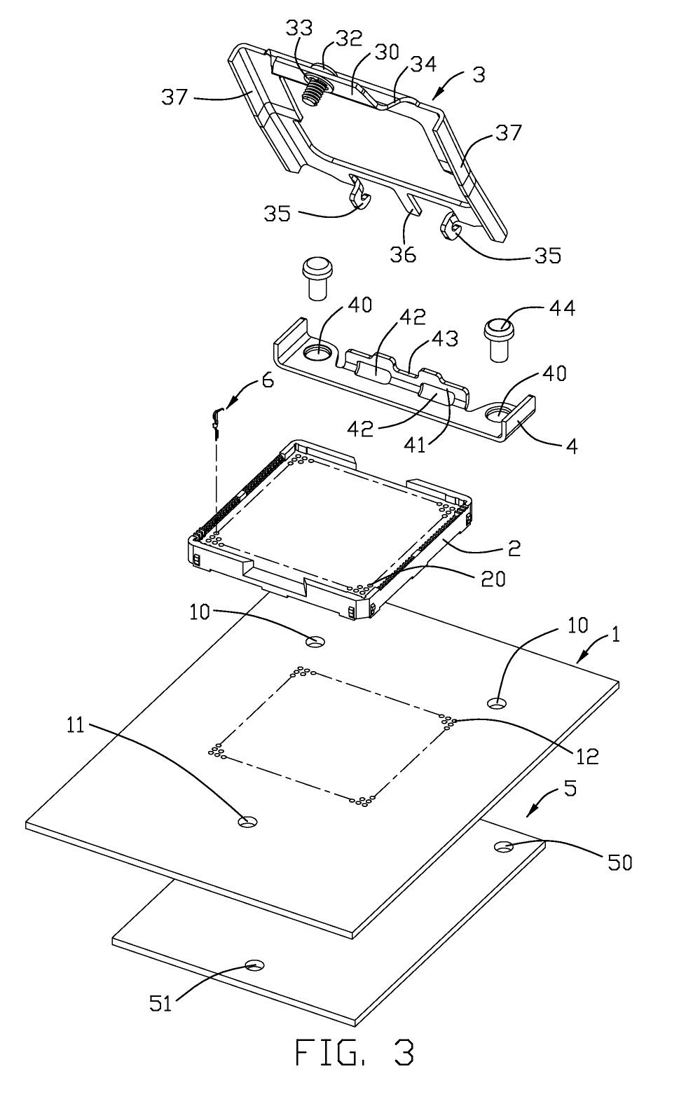

Referring to FIGS. 1 and 3, an electrical connector in accordance with a preferred embodiment of the present invention is generally mounted to a printed circuit board 1 to receive an IC package (not shown). The electrical connector includes a socket body 2 with a plurality of electrical contacts 6 secured thereon, a metal load plate 3 covering the socket body 2, a retention frame 4 for securing the load plate 3 on the printed circuit board 1, and a back plate 5. A fastener such as a first bolt 32 is provided to engage with the load plate 3 and fastens the load plate 3 on the printed circuit board 1.

The IC package is seated to the socket body 2 to make electrical connection with the contacts 6. The load plate 3 is connected with and supported by the retention frame 4. The socket body 2 defines a plurality of passages 20 extending therethrough for receiving the contacts 6. The socket body 2, load plate 3, and retention frame 4 are located on a top side of the printed circuit board 1.

Please referring to FIG. 3, the printed circuit board 1 has a first hole 11 at a first end and a pair of second holes 10 at a second end. The back plate 5 is located at a bottom side of the printed circuit board 1 and provided with a first screw hole (the thread thereof is not shown) 51 corresponding to the first hole 11 and a pair of second through holes (the thread thereof is not shown) 50 corresponding to the second holes 10 of the printed circuit board 1.

The retention frame 4 is made by punching metal plate and located at one side of the socket body 2 on the printed circuit board 1. The retention frame 4 is arranged at one side of the socket body 2 and spaced from the socket body 2. The retention frame 4 is mounted to the second holes 50 by a pair of second bolts 44. The retention frame 4 has a base (not labeled) and a vertical plate 41 extending upwardly from the base. A pair of holes 40 are defined on the retention frame 4 for the second bolts 44 extending therethrough. The vertical plate 41 defines a pair of recesses 42 and a gap 43 located therebetween. Each second bolt 44 extends through the holes 40, 50 and engages with the screw hole 50 of the back plate 5.

The load plate 3 is hollow and defines an opening (not labeled). The load plate 3 includes a frame 37 and a tongue 30 at a first side of the frame 37. The tongue 30 has a first section 34 bending from the frame 37 and a second section (not labeled) extending outwardly from the first section 34. A hole (not labeled) is defined on the second section of the tongue 30. The first bolt 32 engages with the screw hole 51 of the back plate 5. The load plate 3 has a pair of hooks 35 bending downwardly for projecting into the recesses 42 for clasping the retention frame 4 at a second side thereof, and a press piece 36 between the hooks 35. The load plate 3 rotates towards or away from the socket body 2 between an open position to a close position. When the load plate 3 is at the close position, the tongue 30 contacts with a top face (not labeled) of the printed circuit board 1 and the press piece 36 is located in the gap 43 of the retention frame 4. The hooks 35 and the press piece 36 of the load plate 35 rotate around the retention frame 4 from the close position to the open position.

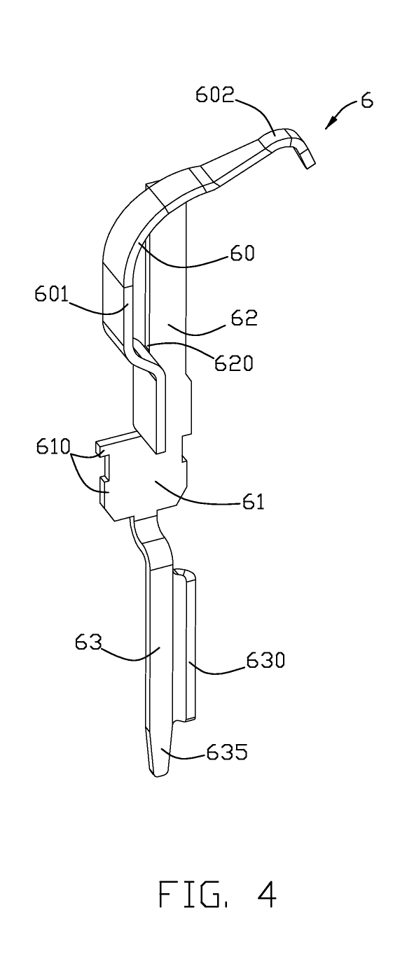

Please referring to FIG. 4, the contacts 6 are received in the passageways 20 and each includes a base section 61, a vertical retention section 62 upwardly extending from the base section 61, a contact section 60 bending from the retention section 62, and a tail section 63 extending downwardly from the base section 61. The base section 61 and the retention section 62 are used to secure the contact 60 in the socket body 2. The contact section 60 is bent from a side edge 620 of the retention section 62 and includes a spring section 601 and a tip section 602 formed at a top end of the spring section 601 for electrically contacting with the IC package. The spring section 601 is not only extending upwardly after bending from the retention section 62, and but also transversely so that the tip section 602 is offset from the tail section 63 in the vertical direction. A plurality of barbs 610 are formed on the base section 61 to engage with the socket body 2. The tail section 63 is inserted into a through hole 12 of the printed circuit board 1 and includes a stick section 635 connecting with the base section 61 and a reinforcement section 630 bending from a lateral edge of the stick section 635 thereby enhancing rigidity thereof and avoiding damage.

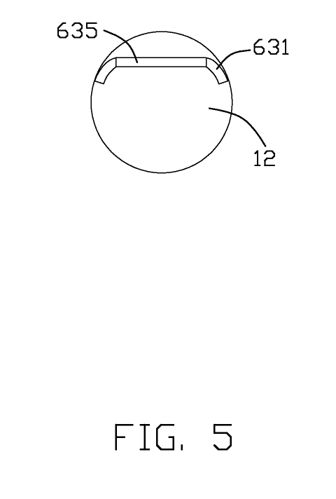

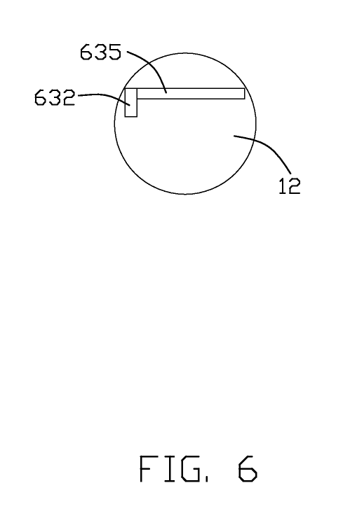

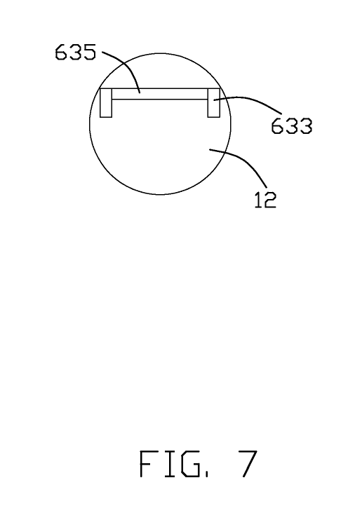

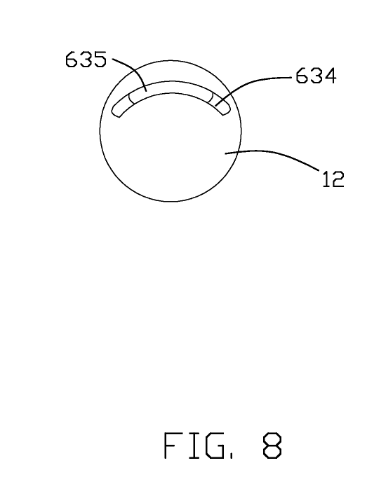

FIGS. 5-8 shows other embodiments according to the present invention which are similar to the contact 6 of the first embodiment except the tail section. As shown in FIG. 5, in a second embodiment, the tail section is received in the through hole 12 of the printed circuit board 1 and includes a pair of reinforcement sections 631 bending from opposite sides of the stick section 635. According to a third embodiment of the present invention which is shown in FIG. 6, a reinforcement section 632 is perpendicular to the stick section 635 and is defined at one side thereof. Please referring to FIG. 7, there is a pair of reinforcement sections 633 at opposite sides of the stick section 635 and perpendicular thereto. In FIG. 8, the tail section includes a curve stick section 635 and a pair of curve reinforcement sections 634 so that the tail section is configured as a circular arc.

Although the present invention has been described with reference to particular embodiments, it is not to be construed as being limited thereto. Various alterations and modifications can be made to the embodiments without in any way departing from the scope or spirit of the present invention as defined in the appended claims.

We claim:

1. An electrical connector for electrically connecting a package with printed circuit board, comprising:
a socket body;
a retention frame adjacent to the socket body;
a load plate attached to the retention frame and capable of rotating toward or away from the socket between an open position to a close position; and
a plurality of contacts attached to the socket body and each comprising a base section, a retention section extending upwardly from the base section, a contact section bending from the retention section, and a tail section extending downwardly from the base section, the tail section including a stick section and a reinforcement section bending from the stick section.

2. The electrical connector as claimed in claim 1, wherein the tail section further comprises the other reinforcement section bending form the stick section.

3. The electrical connector as claimed in claim 1, wherein the reinforcement section is perpendicular to the stick section.

4. The electrical connector as claimed in claim 1, wherein the reinforcement section and the stick section are curve.

5. The electrical connector as claimed in claim 1, wherein the load plate and the retention frame are made of metal plate, and the load plate covers the socket body and includes a frame and a tongue bending downwardly and extending outwardly from the frame.

6. The electrical connector as claimed in claim 5, wherein the fastener extends through a hole on the tongue, and is retained on the tongue by a ring.

7. The electrical connector as claimed in claim 5, wherein the retention frame has a base and a vertical plate extending upwardly from the base, and the vertical plate defines a pair of holes thereon for respectively engaging with hooks formed on the other end of the load plate.

8. An electrical connector for electrically connecting an IC package with a printed circuit board, comprising:
a socket body with a plurality of passageways extending therethrough; and
a plurality of electrical contacts received in the passageways and each comprising a base section, a contact section extending upwardly from the base section for contacting with the IC package, and a tail section extending downwardly from the base section, the tail section being received in through holes of the printed circuit board and including a stick section and a reinforcement section bending from the stick section.

9. The electrical connector as claimed in claim 8, wherein the contact section includes a spring section and a tip section formed at a top end of the spring section.

10. The electrical connector as claimed in claim 9, wherein the spring section is not only extending upwardly from the base section but also extending transversely, the tip section is offset from the tail section in a vertical direction.

11. The electrical connector as claimed in claim 8, wherein the tail section further comprises the other reinforcement section bending form the stick section.

12. The electrical connector as claimed in claim 8, wherein the reinforcement section is perpendicular to the stick section.

13. The electrical connector as claimed in claim 8, wherein the reinforcement section and the stick section are curve.

14. An electrical connector comprising:
an insulative housing defining a plurality of passageways extending in a vertical direction; and
a plurality of contacts disposed in the corresponding passageways, respectively, each of said contacts defining a vertical base section, above which a curved contacting section upwardly extending and below which a strip like tail section downwardly extending with an offset region thereof; wherein
a tail section is equipped with at least a reinforcement section unitarily extending along an elongated side edge thereof.

15. The electrical connector as claimed in claim 14, wherein said contact further includes a retention section upwardly extending from the base section, and said reinforcement section is essentially under said retention section.

16. The electrical connector as claimed in claim 14, wherein said tail section is further equipped with another reinforcement section unitarily extending along another elongated side edge thereof.
